(19) United States
(12) Patent Application Publication
(10) Pub. No.: US 2014/0026718 A1
(43) Pub. Date: Jan. 30, 2014

(54) DEVICE FOR AUTOMATICALLY STRIPPING CABLES

(71) Applicants: TEN-CHEN HO, Tu-Cheng (TW); XIAO-LIAN HE, Shenzhen City (CN)

(72) Inventors: TEN-CHEN HO, Tu-Cheng (TW); XIAO-LIAN HE, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 13/587,948

(22) Filed: Aug. 17, 2012

(30) Foreign Application Priority Data
Jul. 27, 2012 (CN) 2012102629517

(51) Int. Cl. H02G 1/12

(52) U.S. Cl. 81/9.51

(57) ABSTRACT

A device for automatically stripping insulation of a cable includes a rack, a guiding pole, a slide pole, a clamping mechanism, a cutting mechanism, and a controlling mechanism. The guiding pole includes a first pole fastened to the first end of the rack, a second pole spaced from the first pole, and a third pole spaced from the second pole and fastened to the second end of the rack. The guiding pole defines a through hole. The third pole defines a groove parallel to the through slot. The slide pole is slidable to the third pole. A photosensitive sensor is mounted to the slide pole and aligned with the groove to detect the cable. The cutting mechanism includes two blades located between the second pole and the third pole. The controlling mechanism is electrically connected to the photosensitive sensor, the clamping mechanism, and the cutting mechanism.

### BACKGROUND

1. Technical Field

The present disclosure relates to a device for automatically stripping insulation layers from cables.

2. Description of Related Art

When a plurality of bared cables is needed in industrial production, an operator generally operates a cable stripper to strip the insulation layers from the cables, which is inefficient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a device for automatically stripping cables, wherein a box of the device is omitted.

FIG. 2 is a partial, perspective view of FIG. 1, showing a different aspect.

FIG. 3 is similar to FIG. 1, but showing the box.

FIG. 4 is an enlarged view of a circled portion IV of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

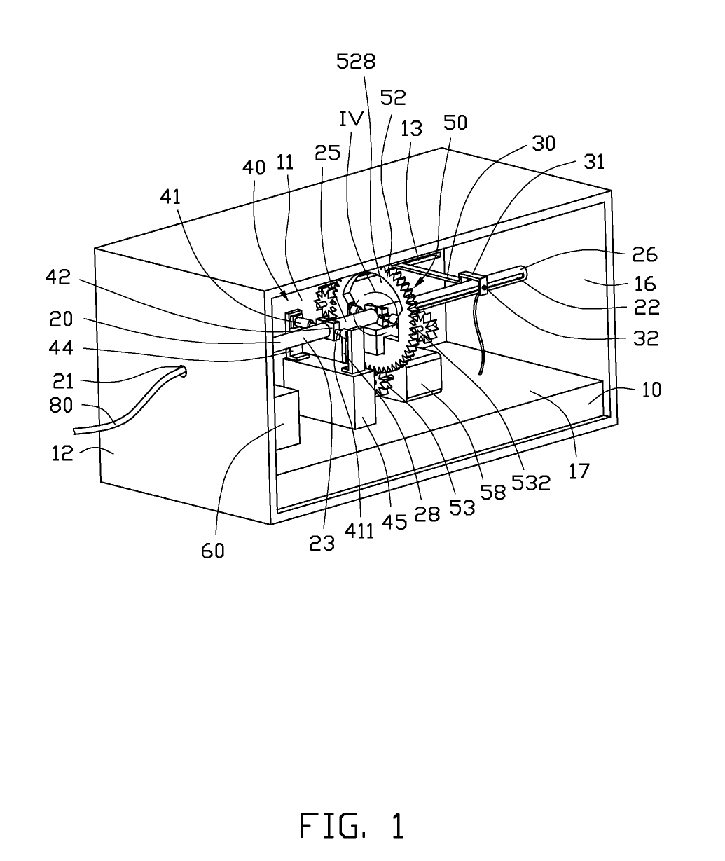

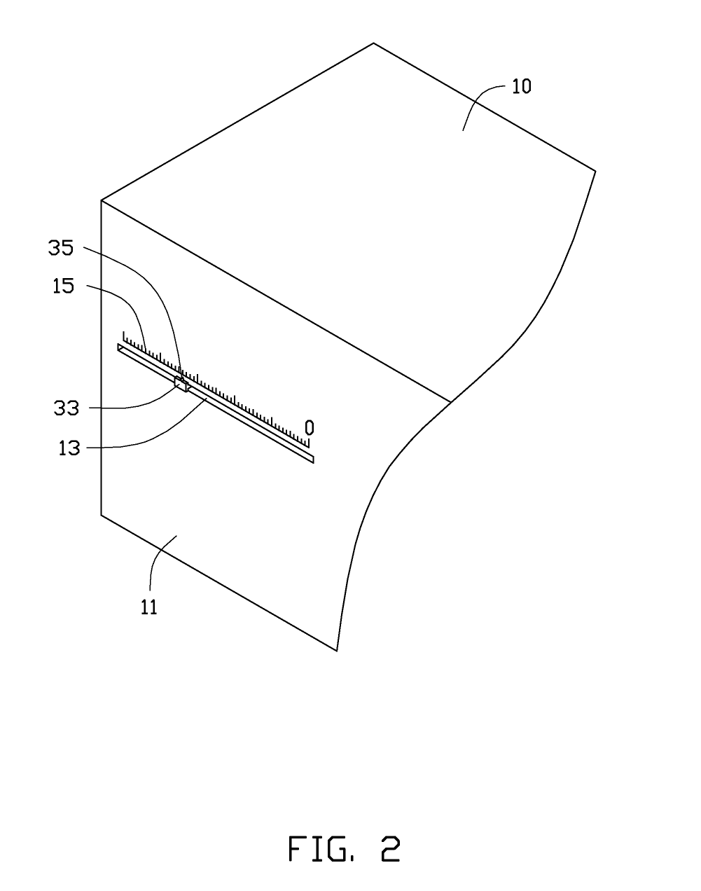

FIGS. 1 and 2 show an exemplary embodiment of a device for automatically stripping ends of insulation layers of cables 80. The automatic device includes a rack 10, a long guiding pole 20, a slide pole 30, a clamping mechanism 40, a cutting mechanism 50, and a controlling mechanism 60.

The rack 10 includes a bottom plate 17, a first end plate 12, a second end plate 16 opposite to the first end plate 12, and a rear plate 11 connected between the first end plate 12 and the second end plate 16. A slide slot 13 is defined in the rear plate 11, adjacent to the second end plate 16 and parallel to the bottom plate 17. A scale line 15 is marked on the outside of the rear plate 11, located above and parallel to the slide slot 13. Scale zero (“0”) is marked at an end of the scale line 15 away from the second end plate 16. A supporting body 28 is formed on the bottom plate 17.

The guiding pole 20 includes a first pole 23 fastened to the first end plate 12, a second pole 25 spaced from the first pole 23 and supported by the supporting body 28, and a third pole 26 spaced from the second pole 25 and fastened to the second end plate 16. The first, second, and third poles 23, 25, and 26 are coaxial. A through hole 21 is axially defined in the guiding pole 20, extending through opposite ends of the pole 20. The diameter of the through hole 21 is slightly larger than the diameter of the cable 80. A groove 22 is longitudinally defined in the third pole 26, extending through front and rear sides of the third pole 26 and communicating with the through hole 21.

The slide pole 30 includes a substantially U-shaped clamping portion 31 at a front end, and a slide block 33 at a rear end. The clamping portion 31 slidably rests on the circumference of the third pole 26. A photosensitive sensor 32, such as an infrared sensor, is mounted to the clamping portion 31, aligning with the groove 22. The slide pole 30 adjacent to the slide block 33 extends through the slide slot 13, and the slide block 33 abuts the rear side of the rear plate 11. A point portion 35 extends up from a top of the slide block 33. The distance from the point portion 35 to the second end plate 16 is the same as the distance from the photosensitive sensor 32 to the second end plate 16.

The clamping mechanism 40 includes a supporting member 45 fastened to the bottom plate 17, two L-shaped connection plates 44 fastened on a top of the supporting member 45, two cylinders 41 fastened to the connection plates 44 toward each other, and two clamping blocks 42 connected to piston rods 411 of the cylinders 41. The clamping blocks 42 are located between the first pole 23 and the second pole 25.

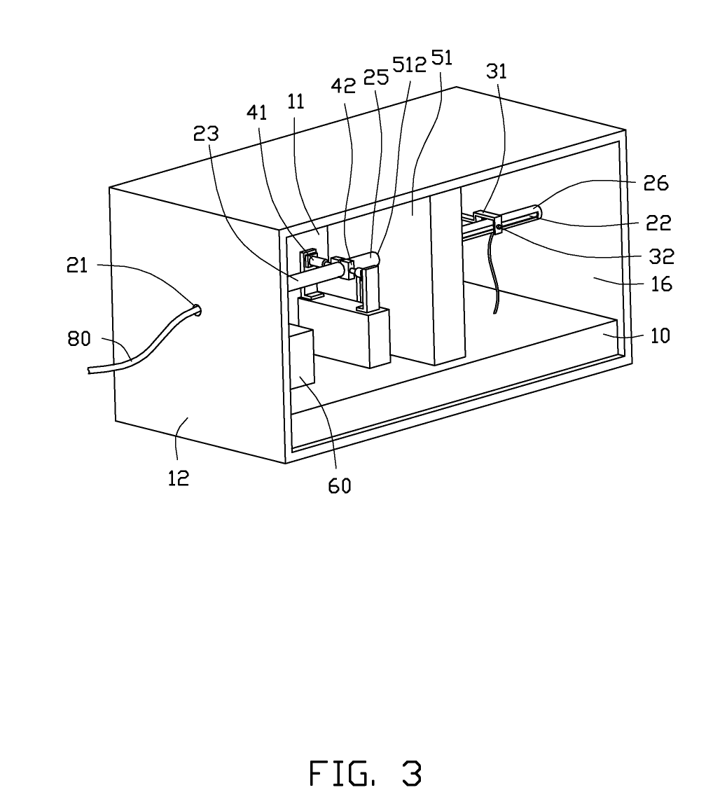

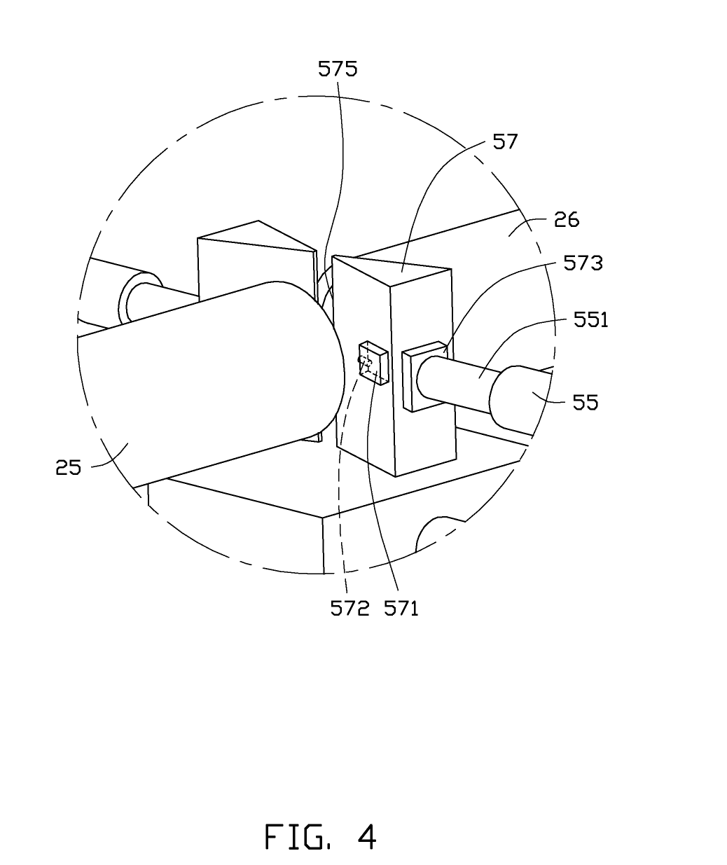

FIGS. 1, 3, and 4 show the cutting mechanism 50 including a box 51, a hollow gear 52 with a receiving space 528 defined in the center of the gear 52, four small gears 53 in a planetary arrangement around the gear 52, two cylinders 55 located in the receiving space 528, two blades 57, and a motor 58 mounted on the bottom plate 17 and located out of the box 51. The gears 52 and 53, the cylinders 55, and the blades 57 are all enclosed by the box 51. The gears 53 mesh with the gear 52. A shaft 532 of the bottom gear 53 is connected to the motor 58 by coupling. Opposite ends of shafts 532 of the other gears 53 are connected to the box 51. A side of the box 51 defines a hole 512 aligning with the second pole 25, and an opposite side of the box 51 defines a hole aligning with the third pole 26, allowing the interior of the box 51 to communicate with the through hole 21. The cylinders 55 are fastened to opposite sides of the receiving space 528 of the gear 52. The blades 57 are located between the second pole 25 and the third pole 26, aligning with each other. A connection block 573 is fastened to each blade 57, and connected to a piston rod 551 of the corresponding cylinder 55. A fastening block 571 is fastened to a lateral surface of each blade 57. A distance sensor 572, such as a laser distance sensor, is mounted to each fastening block 571. The distance from the distance sensor 572 to a top of the fastening block 571 is the same as the distance from the distance sensor 572 to a bottom of the fastening block 571. The distance from the distance sensor 572 to a cutting edge 575 of the corresponding blade 57 along an axial direction of the piston rod 551 is E. The scale zero of the scale line 15 is adjacent to the second end plate 16, relative to the blades 57. The distance from the cutting edge 575 of each blade 57 to the scale zero of the scale line 15 along an axial direction of the guiding pole 20 is M.

The controlling mechanism 60 is a programmable logic controller or a single-chip microcomputer, electrically connected to the photosensitive sensor 32, the distance sensors 572, the motor 58, and electromagnetic valves of the cylinders 41 and 55.

In use, assuming the thickness of the insulation layer of the cable 80 is B. When a first end of the insulation layer of the cable 80, having a length N which is longer than M, needs to be stripped, the slide block 33 of the slide pole 30 is slid to allow the point portion 35 to move to point scale P of the scale line 15, where P=N−M. The clamping portion 31 is slid along the slide pole 30. When the point portion 35 points the scale P, the distance from the photosensitive sensor 32 to the cutting edges 575 along the axial direction of the guiding pole 20 is N. The first end of the cable 80 is placed in the through hole 21 from the first end plate 12. When the first end of the cable 80 is moved to be detected by the photosensitive sensor 32, the photosensitive sensor 32 sends signals to the controlling mechanism 60, the controlling mechanism 60 receives the signals and then controls the cylinders 41 to drive the clamping blocks 42 to move toward each other. The cable 80 is clamped by the clamping blocks 42. Each distance sensor 572 measures a distance C from the distance sensor 572 to the cable 80, and sends signals to the controlling mechanism 60. The controlling mechanism 60 processes relevant data and controls the cylinders 55 to drive the corresponding blades 57 to move distance D to cut through the insulation of the cable 80, where D=B+C−E. The controlling mechanism 60 controls the motor 58 to operate, to rotate the bottom gear 53 connected to the motor 58, and so to rotate the gear 52. When the gear 52 revolves once, the blades 57 also move one revolution around the cable 80, to strip the insulation layer with the length of N at the first end of the cable 80.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A device for automatically stripping an insulation layer of a cable, comprising:
a rack comprising a first end, and a second end opposite to the first end;
a guiding pole comprising a first pole at a first end of the guiding pole and fastened to the first end of the rack, a second pole at a middle of the guiding pole and spaced from the first pole, and a third pole at a second end of the guiding pole and spaced from the second pole, the third pole fastened to the second end of the rack, the guiding pole defining a through hole extending through the opposite first and second ends of the guiding pole, the third pole defining a groove parallel to and communicating with the through hole;
a slide pole slidable to the third pole, a photosensitive sensor mounted to the slide pole and aligned with the groove to detect the cable;
a clamping mechanism;
a cutting mechanism comprising two blades located between the second pole and the third pole; and
a controlling mechanism electrically connected to the photosensitive sensor, the clamping mechanism, and the cutting mechanism;
wherein when the cable is being inserted into the through hole of the guiding pole and detected by the photosensitive sensor, the photosensitive sensor sends signals to the controlling mechanism, the controlling mechanism controls the clamping mechanism to clamp the cable, and controls the cutting mechanism to drive the blades to cut through the insulation layer of the cable.

2. The device of claim 1, wherein the rack further comprises a rear plate marked with a scale line on an outer side of the rear plate, the slide pole comprises a first end slidably connected to the third pole, and a second end comprising a point portion capable of sliding along and pointing the scale line.

3. The device of claim 2, wherein a substantially U-shaped clamping portion is formed on the first end of the slide pole to slidably rest on the circumference the third pole, the photosensitive sensor is mounted to the clamping portion.

4. The device of claim 2, wherein the rear plate defines a slide slot parallel to the scale line, the slide pole slidably extends through the slide slot, a slide block is formed on the second end of the slide pole to slidably abut the outer side of the rear plate, the point portion extends from the slide block.

5. The device of claim 2, wherein a distance from the photosensitive sensor to the second end of the rack is the same as a distance from the point portion to the second end of the rack.

6. The device of claim 1, wherein the clamping mechanism comprises a supporting member fastened to the rack, two opposite L-shaped connection plates fastened on a top of the supporting member, two cylinders fastened to the connection plates, and two clamping blocks driven by the cylinders, the clamping blocks are located between the first pole and the second pole to clamp the cable.

7. The device of claim 1, wherein a distance sensor is mounted to each blade to measure a distance from the distance sensor to the cable, and sends signals to the controlling mechanism to drive the blades to cut the insulation of the cable.

8. The device of claim 1, wherein the cutting mechanism further comprises a box, and a first gear and four second gears received in the box, the second gears mesh with the first gear, the first gear is hollow and defines a receiving space in a center thereof, two cylinders are fastened to opposite sides of the receiving space of the first gear to drive the blades.

9. The device of claim 8, wherein the controlling mechanism controls a motor to drive one of the second gears, shafts of the other second gears are connected to the box.
